(19) United States
(12) Patent Application Publication
(10) Pub. No.: US 2006/0284906 A1
(43) Pub. Date: Dec. 21, 2006

(54) Inkjet image forming apparatus and high-quality printing method of the same

(76) Inventors: Jin-wook Jeong, Yongin-si (KR); Soo-hyun Kim, Suwon-si (KR)

Correspondence Address: STANZIONE & KIM, LLP, 919 18TH STREET, N.W., SUITE 440, WASHINGTON, DC, 20006, US

(21) Appl. No.: 11/354,967

(22) Filed: Feb. 16, 2006

(30) Foreign Application Priority Data
Jun. 17, 2005 (KR) 2005-52543

(51) Int. Cl. B41J 29/38

(52) U.S. Cl. 347/5

(57) ABSTRACT

An inkjet image forming apparatus and a high-quality printing method. The inkjet image forming apparatus for high-quality printing includes a plurality of printheads with lengths equal to a half-width of a print medium are arranged in a single line along a transferring direction of the print medium transferred in a subsidiary scanning direction, and are moveable along a main scanning direction to eject ink onto the print medium to print an image, a plurality of carriages where the plurality of printheads are mounted, a plurality of carriage moving units to reciprocally move the carriages in the main scanning direction, and a control unit to generate control signals to synchronize ejecting operations of the printheads and operations of the carriage moving units so that the ink ejected from the printheads is deposited on a desired area of the print medium.

### CROSS-REFERENCE TO RELATED APPLICATIONS

This application claims the benefit of Korean Patent Application No. 2005-52543, filed on Jun. 17, 2005, in the Korean Intellectual Property Office, the disclosure of which is incorporated herein in its entirety by reference.

### BACKGROUND OF THE INVENTION

1. Field of the Invention

The present general inventive concept relates to an image forming apparatus, and more particularly, to an image forming apparatus to enhance printing quality at high-speed printing and a high-quality printing method of the same.

2. Description of the Related Art

In general, an inkjet image forming apparatus forms images by ejecting ink from a printhead, which is placed a predetermined distance apart from a print medium and reciprocally moves in a direction perpendicular to a transferring direction of the print medium. Such an inkjet image forming apparatus is referred to as a shuttle type inkjet image forming apparatus. A nozzle unit having a plurality of nozzles to eject ink is installed in the printhead of the shuttle-type inkjet image forming apparatus.

Recently, a printhead having a nozzle unit with a length corresponding to a width of a print medium has been used to obtain high-speed printing. An image forming apparatus operated in this manner is referred to as a line printing type inkjet image forming apparatus. In the line printing type inkjet image forming apparatus, the printhead is fixed and only the print medium is transferred. Accordingly, a driving device of the line printing type inkjet image forming apparatus is simple and high-speed printing can be performed. However, if a desired resolution is higher than an original printhead resolution, it is difficult to obtain a printing image having the desired high resolution. Since the printhead in the line printing type inkjet image forming apparatus is fixed, interlacing, i.e., ejecting an ink droplet onto a space between ink dots ejected from the nozzles, is impossible, and thus a high-quality image cannot be obtained. The impossibility of the interlacing may be a hindrance for inkjet image forming apparatuses designed for high-quality printing. In addition, since the printhead of the line printing type image forming apparatus is fixed, it is difficult to compensate for a malfunctioning nozzle. Furthermore, the entire printhead must be replaced when a malfunctioning nozzle exists, and thus the maintenance costs associated with the line printing type inkjet image forming apparatus increase. In addition, if the printhead is formed of head chips, the printhead with a length corresponding to the width of the print medium must include many head chips, and thus the generation of malfunctioning nozzles is increased. Thus, an inkjet image forming apparatus having an improved structure to overcome such limitations is needed.

### SUMMARY OF THE INVENTION

The present general inventive concept provides an inkjet image forming apparatus and a high-quality printing method that can increase throughput using a printhead and that has a reduced size.

The present general inventive concept also provides an inkjet image forming apparatus and a high-quality printing method that can realize high-speed printing as well as high-quality printing.

The present general inventive concept also provides an inkjet image forming apparatus and a high-quality printing method that can compensate for a malfunctioning nozzle.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing an inkjet image forming apparatus including a plurality of printhead units having lengths equal to a half-width of a print medium, being arranged along a transferring direction of the print medium transferred in a subsidiary scanning direction, being moveable along a main scanning direction, and having a plurality of nozzle units mounted thereon to eject ink onto the print medium to print an image, a plurality of carriages corresponding to the plurality of printhead units upon which the plurality of nozzle units each having a plurality of nozzles are mounted, a plurality of carriage moving units corresponding to the plurality of carriages to reciprocally move the plurality of carriages in the main scanning direction, and a control unit to generate control signals to synchronize ejecting operations of the plurality of nozzle units and operations of the plurality of carriage moving units so that the ink ejected from the plurality of printhead units is deposited on a desired area of the print medium.

The plurality of printhead units may include a first printhead unit and a second printhead unit.

The control unit may generate a control signal to arrange the first and second printhead units to be parallel to each other along a width direction of the print medium to print an area corresponding to a width of the print medium.

The control unit may generate a control signal to reciprocally move the first and second printhead units in the main scanning direction such that ink dots ejected by one of the printhead units are deposited on positions between ink dots ejected by the other of the printhead units.

The control unit may generate a control signal to control one of the printhead units to compensate for a malfunctioning nozzle in another of the printhead units.

The control unit may generate a control signal to arrange the first and second printhead units to be parallel to each other when printing in a high-quality mode. The control unit may generate a control signal to deposit ink dots ejected by one of the printhead units at positions between ink dots ejected by the other of the printhead units.

Each of the plurality of carriage moving units may include a main frame, a carriage moving motor, carriage moving rollers, one being connected to the carriage moving motor and another being located in the main frame, and a carriage moving belt connected to a corresponding carriage of the plurality of carriages and supported by the carriage moving rollers to reciprocally move the corresponding carriage of the plurality of carriages in the main scanning direction.

Each of the plurality of carriage moving unit may include a guide rod connected to a corresponding carriage of the plurality of carriages and extending along the main scanning direction; and a reciprocal driving unit to reciprocally move the guide rod in the main scanning direction. The reciprocal driving unit may include a driving motor having a gear, a connection gear including an outer circumference having gear teeth to mesh with the gear and an inner circumference having a female gear, and a lead screw formed on the guide rod to mesh with the female gear of the connection gear.

A plurality of head chips each having a plurality of nozzle arrays may be arranged along the main scanning direction in each of the plurality of printhead units.

The plurality of head chips may be arranged in a zigzag pattern in each of the plurality of printhead units.

The foregoing and/or other aspects and utilities of the present general inventive concept may also be achieved by providing a high-quality printing method of an inkjet image forming apparatus having first and second printhead units having lengths equal to the half-width of a print medium and being arranged in a single line along the transferring direction of the print medium transferred in a subsidiary scanning direction, the first and second printhead units being moveable along the main scanning direction to eject ink onto the print medium to print an image, the method comprising receiving a printing environment input from a host, and printing an image by moving the first and second printhead units according to the input printing environment.

The printing of the image may include printing by arranging the first and second printhead units to be parallel to each other along a width direction of the print medium and printing an area corresponding to the width of the print medium.

The printing of the image may include reciprocally moving the first and second printhead units in the main scanning direction and depositing ink dots ejected by one of the printhead units at positions between ink dots ejected by the other of the print head units.

The printing of the image may include printing by compensating for a malfunctioning nozzle in one of the printhead units by controlling the other of the printhead units to compensate for the malfunctioning nozzle.

The printing of the image may include printing by arranging the first and second printhead units to be parallel to each other along a width direction of the print medium when printing in a high-quality mode.

The high-quality printing method of an inkjet image forming apparatus may further include depositing ink dots ejected by one of the printhead units at positions between ink dots ejected by the other of the printhead units.

The high-quality printing method of an inkjet image forming apparatus may further include printing by moving the first and second printhead units together in the main scanning direction.

The foregoing and/or other aspects and utilities of the present general inventive concept may also be achieved by providing an inkjet image forming apparatus, including a plurality of printhead units disposed along a subsidiary scanning direction parallel to a print medium path; and a controller to selectively move the plurality of printhead units in a main scanning direction having an angle with the print medium path. The plurality of printhead units may be parallel to each other and spaced apart by a distance. The controller may move one of the plurality of printhead units while not moving another one of the plurality of printhead units. The controller may simultaneously move the plurality of printhead units. The plurality of printhead units may include first and second printhead units having first and second nozzle units, and the controller may selectively control the first and second nozzle units while moving at least one of the first and second printhead units. The the first and second nozzle units may include first and second nozzles, and the controller may selectively control the first and second nozzles to compensate for a defective one of the first and second nozzles. The apparatus may further include a print medium, and a distance between the plurality of printhead units and the print medium is about 0.5 mm to about 2.5 mm. The controller may include an interlace controller to control at least one of the plurality of print heads to eject interlacing ink droplets and a malfunction controller to control at least one of the plurality of print heads to compensate for at least one malfunctioning print head. The interlace controller and the malfunction controller may be a single controller.

The foregoing and/or other aspects and utilities of the present general inventive concept may also be achieved by providing an inkjet image printing method, including printing an image by interlacing ink droplets ejected from a plurality of print heads of an inkjet image forming apparatus. The method may further include printing the image by controlling at least one of the plurality of print heads to compensate for at least one malfunctioning print head.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 illustrates a cross-sectional view of an inkjet image forming apparatus according to an embodiment of the present general inventive concept;

FIG. 2 illustrates a plan view of the printhead unit of FIG. 1;

FIG. 3 illustrates the first printhead unit of FIG. 2;

FIG. 4 illustrates a perspective view of the first printhead unit and a first carriage moving unit of FIG. 1 according to an embodiment of the present general inventive concept;

FIG. 5 illustrates a perspective view of the first printhead unit and the first carriage moving unit of FIG. 1 according to another embodiment of the present general inventive concept;

FIG. 6 illustrates a cross-sectional view of a portion of FIG. 5;

FIG. 7 is a block diagram illustrating an image forming system according to an embodiment of the present general inventive concept;

FIG. 8 is a block diagram illustrating the process of an image forming apparatus according to an embodiment of the present general inventive concept;

FIG. 9 illustrates an example of a printing pattern printed by an image forming apparatus according to an embodiment of the present general inventive concept;

FIG. 10 illustrates another example of a printing pattern printed by an image forming apparatus according to an embodiment of the present general inventive concept;

FIG. 11 illustrates still another example of a printing pattern printed by an image forming apparatus according to an embodiment of the present general inventive concept;

FIGS. 12A and 12B illustrate yet another example of a printing pattern printed by an image forming apparatus according to an embodiment of the present general inventive concept;

FIGS. 13A and 13B illustrate a printing pattern printed by an image forming apparatus according to an embodiment of the present general inventive concept when a malfunctioning nozzle is compensated for; and

FIG. 14 is a flow chart illustrating a high-quality printing method of an image forming apparatus according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

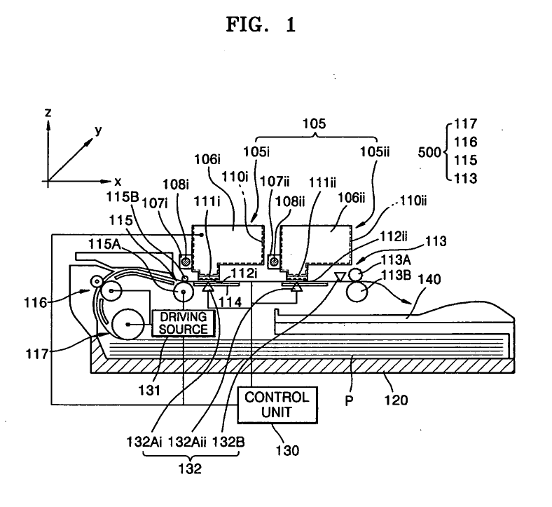

FIG. 1 illustrating a cross-sectional view of an inkjet image forming apparatus according to an embodiment of the present general inventive concept. Referring to FIG. 1, the inkjet image forming apparatus includes a feeding cassette 120, a printhead unit 105, a supporting member 114 opposite to the printhead unit 105, a print medium transferring unit 500 to transfer the print medium P in a subsidiary scanning direction, i.e., an x direction, and a stacking unit 140 on which the print medium P is discharged and stacked.

The print medium P is stacked on the feeding cassette 120. The print medium P is transferred from the feeding cassette 120 to the printhead unit 105 by the print medium transferring unit 500. In the present embodiment, the print medium P is transferred in a subsidiary scanning direction, i.e., an x direction, and the printhead unit 105 is moved in a main scanning direction, i.e., y direction. The subsidiary scanning direction may or may not be perpendicular to the main scanning direction.

The print medium transferring unit 500 transfers the print medium P in the subsidiary scanning direction and includes a pick-up roller 117, an auxiliary roller 116, a feeding roller 115, and a discharging roller 113. The print medium transferring unit 500 is driven by a driving source 131, such as a motor, and provides a transferring force to transfer the print medium P. The driving source 131 is controlled by a control unit 130, which will be described later.

The pick-up roller 117 is installed in one side of the feeding cassette 120. The pick-up roller 117 is rotated while pressing a top side of the print medium P, thereby feeding the print medium P to an outside of the feeding cassette 120.

The feeding roller 115 is installed at an inlet side of the printhead unit 105 and feeds the print medium P drawn out by the pick-up roller 117 to the printhead unit 105. The feeding roller 115 may align the print medium P before the print medium P passes through the printhead unit 105 such that ink can be ejected to a desired area of the print medium P. The feeding roller 115 includes a driving roller 115A to supply a transferring force to transfer the print medium P, and an idle roller 115B elastically engaged with the driving roller 115A. The auxiliary roller 116 that transfers the print medium P may be further installed between the pick-up roller 117 and the feeding roller 115.

The discharging roller 113 is installed at an outlet side of the printhead unit 105 and discharges the print medium P on which the printing has been completed, to an outside of the image forming apparatus. The discharged print medium P is stacked on a stacking unit 140. The discharging roller 113 includes a star wheel 113A installed in a width direction of the print medium P, and a supporting roller 113B which is opposite to the star wheel 113A and supports a rear side of the print medium P. The print medium P may wrinkle due to ink ejected onto a top side of the print medium P while passing through the printhead unit 105. If wrinkling is severe, the print medium P contacts the bottom surface of the printhead unit 105, wet ink is spread on the print medium P, and an image printed thereon may be contaminated. The distance between the print medium P and the printhead unit 105 may not be maintained due to the wrinkles of the print medium P. The star wheel 113A prevents the print medium P fed in a downward direction of the printhead unit 105 from contacting the bottom surface of the printhead unit 105, and/or prevents the distance between the print medium P and the bottom surface of the printhead unit 105 from being changed. The star wheel 113A is installed such that at least a portion of the star wheel 113A protrudes from the printhead unit 105, and contacts at a point of a top surface of the print medium P According to the above structure, the star wheel 113A contacts the point of the top side of the print medium P so that an ink image that has been ejected from the printhead unit 105 but is not yet dried is prevented from being contaminated. In addition, a plurality of star wheels 113A may be installed so as to smoothly transfer the print medium P. When the plurality of star wheels 113A are installed in parallel with the transferring direction of the print medium P, a plurality of supporting rollers corresponding to the star wheels may be further installed.

When printing is continuously performed, the print medium P is discharged and stacked on the stacking unit 140 and subsequently a next print medium P is discharged before the ink on the top side of the previous print medium P is dried, so that the rear side of the print medium P may be contaminated by ink. To prevent this problem, an individual drying unit (not illustrated) may be further installed.

The supporting member 114 is installed below the printhead unit 105 and supports the rear side of the print medium P to maintain a predetermined distance between the printhead unit 105 and the print medium P The distance between the printhead unit 105 and the print medium P is about 0.5- about 2.5 mm.

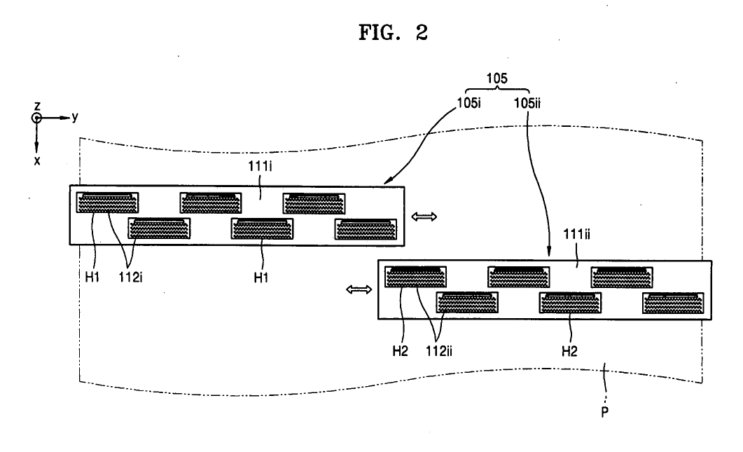

FIG. 2 illustrates a plan view of the printhead unit 105 of FIG. 1. Referring to FIGS. 1 and 2, the printhead unit 105 prints an image by ejecting ink onto the print medium P and includes a plurality of printhead units with lengths equal to or greater than a half-width of the print medium P. The plurality of printhead units 105 are arranged in a single line along the transferring direction of the print medium P transferred in the subsidiary scanning direction, i.e., the x direction, and are installed to reciprocally move in the main scanning direction. The plurality of printhead units 105 includes first and second printhead units 105i and 105ii reciprocally moving in the main scanning direction, i.e., y direction (indicated by arrows in FIG. 2). Since, the entire structures and functions of the first and second printhead units 105i and 105ii are the same, only the structure and function of the first printhead unit 105i will be described for convenience of explanation. Elements of the first and second printhead units 105i and 105ii having the same structures and functions are referred in the drawings by separately adding ‘i’ or ‘ii’ to each of the reference numerals.

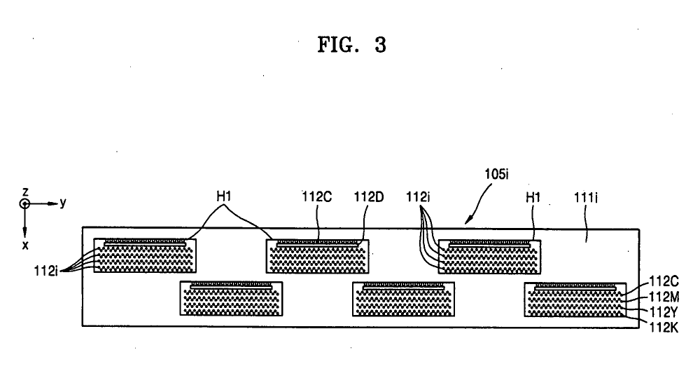

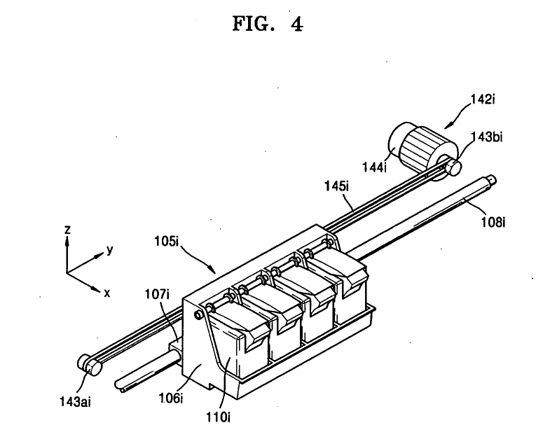

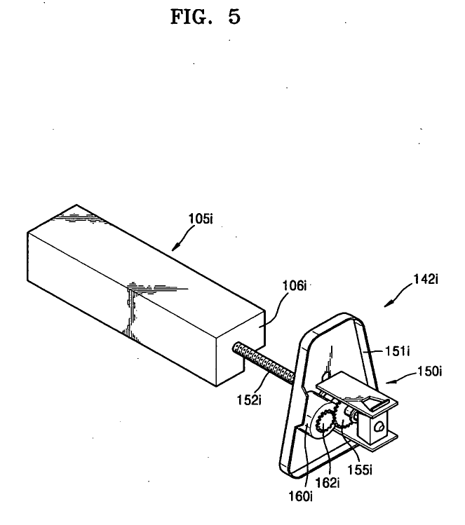

FIG. 3 illustrates the first printhead unit 105i of FIG. 2. Referring to FIGS. 1-3, the first printhead unit 105i includes a first body 110i, a first printhead 111i installed on the bottom surface of the first body 110i, a first nozzle unit 112i formed on the first printhead 111i and a first carriage 106i on which the first body 110i is mounted. The first body 110i having the first printhead 111i is mounted into the first carriage 106i in a cartridge type manner and the first carriage 106i is reciprocally moved in the main scanning direction, i.e., the y direction, by a first carriage moving unit 142i, which will be described later with reference to FIGS. 4 and 5. The feeding roller 115 is rotatably installed at an inlet side of the first nozzle unit 112i, and the discharging roller 113 is installed at an outlet side of a second nozzle unit 112ii. Each of the nozzles in the first nozzle unit 112i includes a driving circuit 112D and a cable 112C to receive printing data, electric power, control signals, etc. The cable 112C may be a flexible printed circuit (FPC) or a flexible flat cable (FFC).

The first printhead 111i includes the first nozzle unit 112i disposed along the main scanning direction, i.e., the y direction, and prints an image by ejecting ink onto the print medium P while reciprocally moving in the main scanning direction, i.e., the y direction, or when it stops moving. The first printhead 111i uses heat energy or a piezoelectric device as an ink ejecting source, and is made to have a high resolution through a semiconductor manufacturing process, such as etching, deposition or sputtering. Referring to FIGS. 2 and 3, a plurality of head chips H1 where a plurality of nozzle rows arrays 112C, 112M, 112Y, and 112K are formed are arranged along the main scanning direction, i.e., y direction, in the first printhead 111i. Each of the head chips H1 includes a predetermined number of nozzles and a driving circuit to drive each of the nozzles. That is, each of the plurality of nozzle arrays 112C, 112M, 112Y, and 112K ejecting ink are longitudinally arranged in each of the head chips H1. Each of the head chips H1 may be formed of a single chip having the same length as the first printhead 111i, i.e., the half-width of the print medium P. As discussed above, when the printhead 111ii is formed of a single chip, the entire first printhead 111i must be replaced when one or more nozzles malfunction, thus increasing maintenance costs. Accordingly, the plurality of head chips H1 may be longitudinally arranged, as illustrated in FIGS. 2 and 3. When the plurality of head chips H1 are arranged in a single line, a distance between the head chips H1 may become greater than a distance between the nozzles in the same head chips H1, thereby generating an unprinted portion. Therefore, the plurality of head chips H1 may be arranged in zigzag pattern. The nozzle arrays among the nozzle arrays 112C, 112M, 112Y, and 112K in the head chips H1, which eject ink of the same color, may be disposed to cross one another to enhance a printing resolution in the main scanning direction, i.e., the y direction. When the nozzle arrays are arranged in this manner, ink dots ejected from the nozzle in the nozzle array are deposited at positions between ink dots ejected from the nozzles in the other nozzle array, thereby enhancing the printing resolution in the main scanning direction, i.e., the y direction. The first printhead 111i having the first nozzle unit 112i in the plurality of head chips H1 is described as an example in the present embodiment, and the first nozzle unit 112i may be variously arranged. Although two nozzle arrays ejecting ink of the same color cross each other in the present embodiment, one array may be longitudinally arranged. Therefore, FIG. 3 does not limit the technical scope of the present general inventive concept.

Although not illustrated, a removable cartridge typed ink container can be provided in the first body 110i illustrated in FIG. 1. Further, the first body 110i may include chambers, each of which has ejecting units (for example, piezoelectric elements or heat-driving typed heaters) that are connected to respective nozzles of the first nozzle unit 112i and provide pressure to eject the ink, a passage (for example, an orifice) for supplying ink contained in the first body 110i to each chamber, a manifold that is a common passage for supplying the ink flowed through the passage to the chamber, and a restrictor that is an individual passage for supplying the ink from the manifold to each chamber.

The driving unit (not illustrated) provides an ink ejecting force and drives the nozzles in the nozzle unit 112i in a time-sharing manner to print an image. The driving unit may be, for example, one of two types of driving units according to an actuator that provides an ejecting force to ink droplets. The first type is a thermal driving printhead that generates bubbles in ink using a heater, thereby ejecting ink droplets due to an expanding force of the bubbles. The second type is a piezoelectric driving printhead that ejects ink droplets using pressure applied to ink due to deformation of a piezoelectric device. The ejecting operations of the nozzles in the first nozzle unit 112i disposed in the head chips H1 are controlled by the control unit 130, which will be described later. The chamber, the ejecting unit, the passage, the manifold, and the restrictor are well-known to a person skilled in the art, and thus detailed descriptions thereof will be omitted.

A malfunctioning nozzle is, for example, a nozzle that improperly ejects ink droplets or that fails to eject ink droplets. That is, the malfunctioning nozzle exists, for example, when ink is not ejected from nozzles due to several causes or when a smaller amount of ink droplets is ejected as compared to a non-malfunctioning nozzle. The malfunctioning nozzle may be generated in a process of manufacturing the first printhead 111i or during printing. In general, information on the malfunctioning nozzle generated in the manufacturing process is stored in a memory (not illustrated) installed in the first printhead 111i. On the other hand, the malfunctioning nozzle generated during printing is detected by the detecting unit 132. That is, the detecting unit 132 detects the malfunctioning nozzle of the first nozzle unit 112i formed on the first printhead 111i.

The detecting unit 132 includes a first detecting unit 132Ai to detect a malfunctioning nozzle before printing, and a second detecting unit 132B to detect a malfunctioning nozzle during printing. The first detecting unit 132Ai of the first printhead unit 105i detects whether a nozzle is clogged by radiating light directly onto the nozzle unit 112i, and the second detecting unit 132B detects whether a malfunctioning nozzle exists in the nozzle unit 112i by radiating light onto the print medium P when the print medium P is transferred. As an embodiment of the detecting unit 132, an optical sensor includes a light-emitting sensor (such as a light emitting diode) that radiates light onto the print medium P, and a light-receiving sensor that receives light reflected from the print medium P. The light emitting sensor and the light receiving sensor can be formed as a single body or as several separate units. The structures and functions of the optical sensor are well known to those of ordinary skill in the art, and thus a detailed description thereof will be omitted.

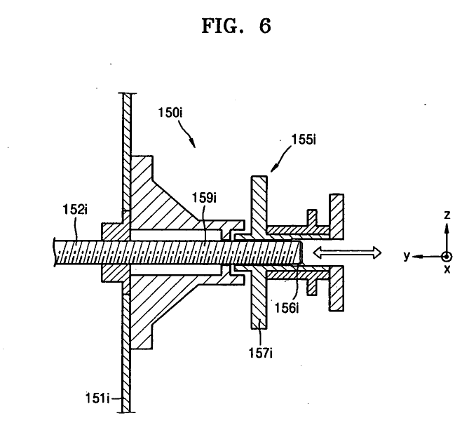

FIG. 4 illustrates a perspective view of the first printhead unit 105i and the first carriage moving unit 142i of FIG. 1 according to an embodiment of the present general inventive concept. FIG. 5 illustrates a perspective view of the first printhead unit 105i and the first carriage moving unit 142i of FIG. 1 according to another embodiment of the present general inventive concept. FIG. 6 illustrates a cross-sectional view of a portion of FIG. 5. Since, the entire structures and functions of the first and second carriage moving units 142i and 142ii are the same, only the structure and function of the first carriage moving unit 142i will be described. Elements of the first and second printhead units 105i and 105ii having the same structures and functions are referred in the drawings by separately adding ‘i’ or ‘ii’ to each of the reference numerals. In FIGS. 4 through 6, like reference numerals denote like elements having the same structures and functions.

An image forming apparatus according to an embodiment of the present general inventive concept includes a plurality of carriages, each having a plurality of printheads mounted therein. A carriage moving unit (e.g., the carriage moving unit 142) reciprocally moves each of the carriages in the main scanning direction.

In the present embodiment illustrated in FIG. 1, a plurality of carriages includes the first carriage 106i where the first printhead 111i is mounted, and the second carriage 106ii where the second printhead 111ii is mounted.

Referring to FIG. 4, the first body 110i is mounted in the first carriage 106i. The first printhead 111i connected to the first body 110i is mounted in a cartridge type manner in the first carriage 106i. The first carriage moving unit 142i reciprocally to move the first carriage 106i in the main scanning direction includes a first carriage moving motor 144i, first carriage moving rollers 143ai and 143bi, and a first carriage moving belt 145i. The first carriage moving motor 144i receives electric power from a main frame (not illustrated) of the image forming apparatus. The first carriage moving roller 143bi is connected to the carriage moving motor 144i, and the first carriage moving roller 143ai is installed in the main frame. The first carriage moving belt 145i is supported by the first carriage moving rollers 143ai and 143bi, and rolls between these rollers. The first carriage moving belt 145i is connected to the first carriage 106i. The first carriage 106i is moveable to a predetermined position by the first carriage moving motor 144i according to a control signal generated by the control unit 130, which will be described later. The reciprocal motion of the first carriage 106i is guided by a first guide shaft 108i. A first combining unit 107i is perforated at one side of the first carriage 106i. The first guide shaft 108i is inserted into the first combining unit 107i formed in a hollow shape and guides the reciprocating motion of the first carriage 106i.

Referring to FIGS. 5 and 6, the first carriage moving unit 142i is connected to the first carriage 106i and includes a first guide rod 152i extending along the main scanning direction, i.e., y direction, and a first reciprocal driving unit 150i which reciprocally moves the first guide rod 152i in the main scanning direction, i.e., the y direction. A first lead screw 159i to mesh with a female gear of a first connection gear 155i is formed on the outer circumference of the first guide rod 152i. The first reciprocal driving unit 150i includes a first frame 151i fixed in the image forming apparatus, the first connection gear 155i which includes a first inner circumference 156i having a female gear meshing with the gear of the first lead screw 159i and a first outer circumference 157i having gear teeth, and a first driving motor 160i fixed at the first frame 151i. The first driving motor 160i includes a first gear 162i to mesh with and to transport a driving force to the first connection gear 155i. When the first gear 162i driven by the first driving motor 160i rotates forwardly or reversely, the first connection gear 155i to mesh with the first gear 162i rotates to transmit the driving force to the lead screw to mesh with the first inner circumference 156i of the first connection gear 155i, and thus the first guide rod 152i is reciprocally moved in the main scanning direction, i.e., the y direction. The first carriage 106i to connect to the first guide rod 152i is also moved in the main scanning direction, i.e., the y direction.

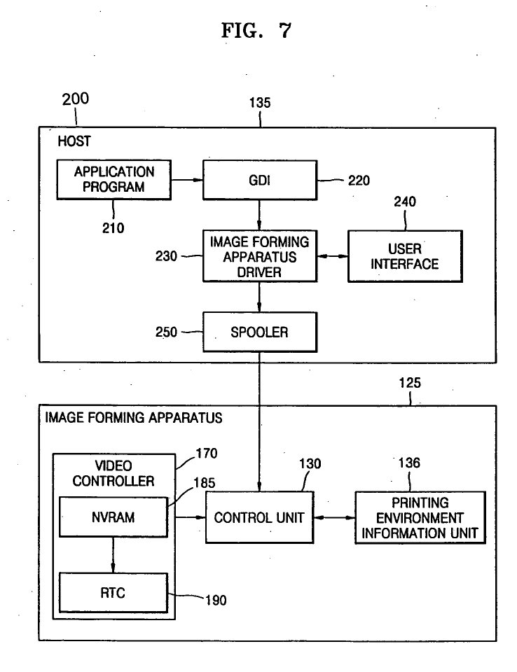

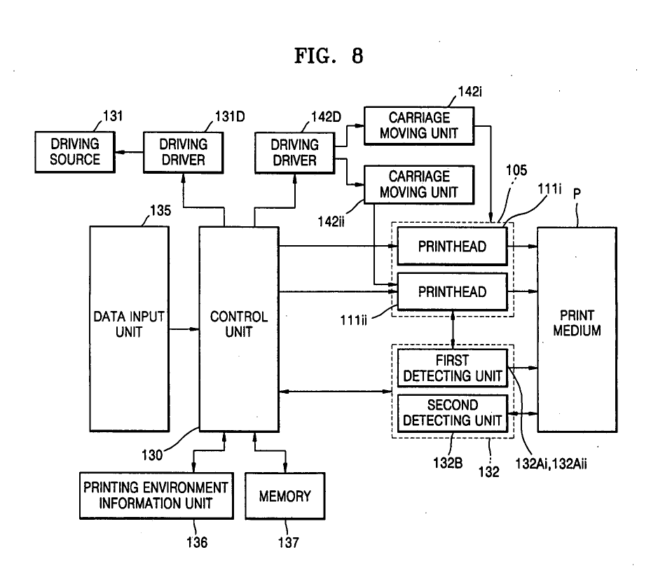

FIG. 7 is a block diagram illustrating an image forming system according to an embodiment of the present general inventive concept. FIG. 8 is a block diagram illustrating the process of an image forming apparatus according to an embodiment of the present general inventive concept. The image forming system includes a data input unit 135 and an inkjet image forming apparatus 125.

Referring to FIG. 7, a data input unit 135 is a host 200, such as a personal computer (PC), a digital camera, or a personal digital assistant (PDA), and receives image data to be printed. The data input unit 135 includes an application program 210, a graphics device interface (GDI) 220, an image forming apparatus driver 230, a user interface 240, and a spooler 250. The application program 210 generates and edits an object that can be printed by the image forming apparatus 125. The GDI 220, which is a program installed in the host 200, receives the object from the application program 210, sends it to the image forming apparatus driver 230, and generates commands related to the object in response to a request from the image forming apparatus driver 230. The image forming apparatus driver 230 is a program installed in the host to generate commands that can be interpreted by the image forming apparatus 125. The user interface 240 for the image forming apparatus driver 230 is a program installed in the computer system and provides environment variables with which the image forming apparatus driver 230 generates commands. The spooler 250 is a program installed in the operating system of the host 200 and transmits the commands generated by the image forming apparatus driver 230 to an input/output device (not illustrated) that is connected to the image forming apparatus 125.

The image forming apparatus 125 includes a video controller 170, a control unit 130, a printing environment information unit 136. The video controller 170 includes a non-volatile random access memory (NVRAM) 185, a static random access memory (SRAM, not illustrated), a synchronous dynamic random access memory (SDRAM), a NOR Flash (not illustrated), and a real time clock (RTC) 190.

The video controller 170 interprets commands generated by the image forming apparatus driver 230 to convert it into corresponding bitmaps and transmits the bitmaps to the control unit 130. The control unit 130 transmits the bitmaps to each component of the image forming apparatus 125 to print an image on a print medium P.

Referring to FIGS. 1, 7, and 8, the control unit 130 is mounted on a motherboard (not illustrated) of the image forming apparatus 125, and generates control signals that synchronize ejecting operations of the first and second nozzle units 112i and 112ii installed in the first and second printheads 111i and 111ii, transferring operations of the print medium transferring unit 500, and operations of the first and second carriage moving units 142i and 142ii. That is, the control unit 130 synchronizes the operation of each component so that the ink ejected from the first and second nozzle units 112i and 112ii can be deposited on a desired area of the print medium P when the printing operation is performed in a predetermined printing environment. The control unit 130 stores the image data input through a data input unit 135 in a memory 137, and confirms whether the image data desired to be printed is completely stored in the memory 137.

The printing environment information unit 136 stores printing environment information corresponding to each printing environment when image data input from the application program 210 is printed in a predetermined printing environment. That is, the printing environment information unit 136 stores printing environment information corresponding to each printing environment input from the user interface 240. Here, the printing environment includes at least one of printing density, resolution, size of a print medium, type of a print medium, temperature, humidity, and continuous printing. The control unit 130 controls the operations of the first and second carriage moving units 142i and 142ii, the first and second printheads 111i and 111ii, and the print medium transferring unit 500 in each printing environment stored in the printing environment information unit 136 corresponding to the input printing environment. For example, the control unit 130 generates control signals for the operation of each component corresponding to a printing mode, such as a normal mode, a draft mode, and a high-quality mode, input from the user interface 240.

If the image data has been completely stored, the control unit 130 generates a control signal corresponding to the input printing environment and transmits it to a driving driver 131D to operate the driving source 131. The print medium P is transferred by the print medium transferring unit 500 driven by the driving source 131. The control unit 130 operates the first and second printheads 111i and 111ii to eject ink onto the print medium P about the same time that the print medium P approaches the printhead unit 105. The control unit 130 generates and outputs control signals to control the first and second printheads 111i and 111ii, and the first and second printheads 111i and 111ii receive the control signals and print image data on the print medium P. Here, the control unit 130 generates a control signal according to printing environment information stored in the printing environment information unit 136 and malfunctioning nozzle information detected by the detecting unit 132, and transmits the control signal to the driving driver 142D to operate the first and second carriage moving units 142i and 142ii for printing.

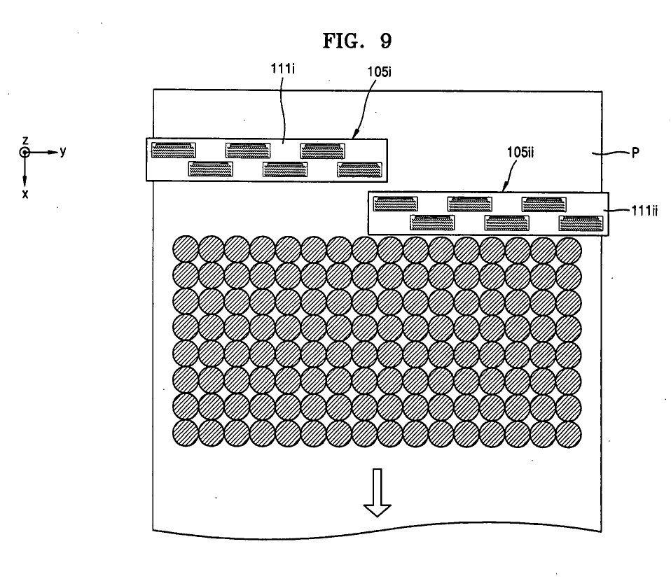

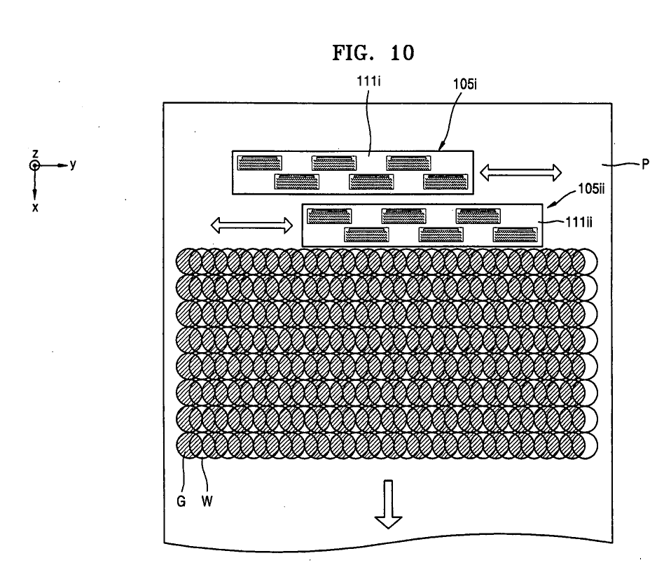

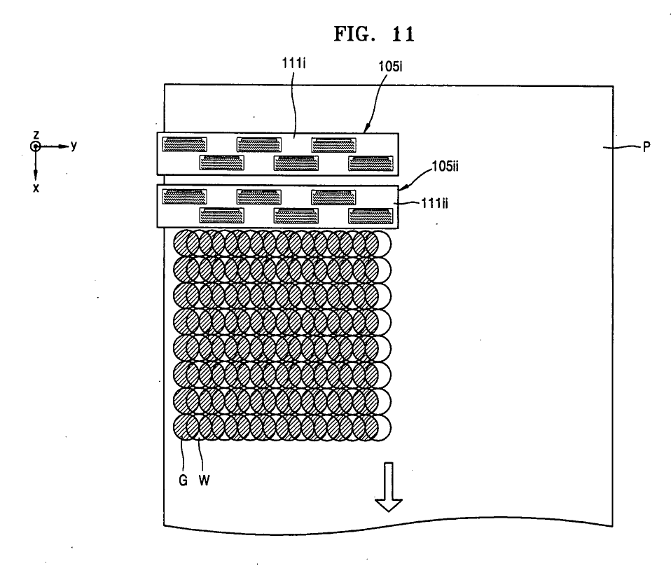

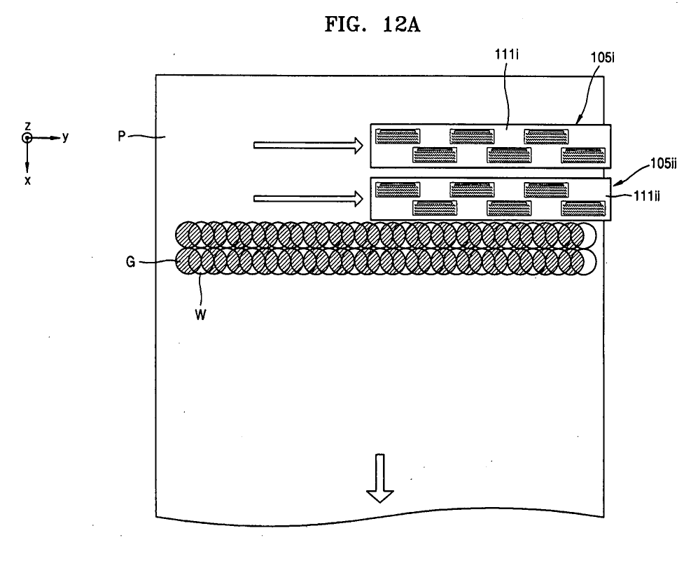

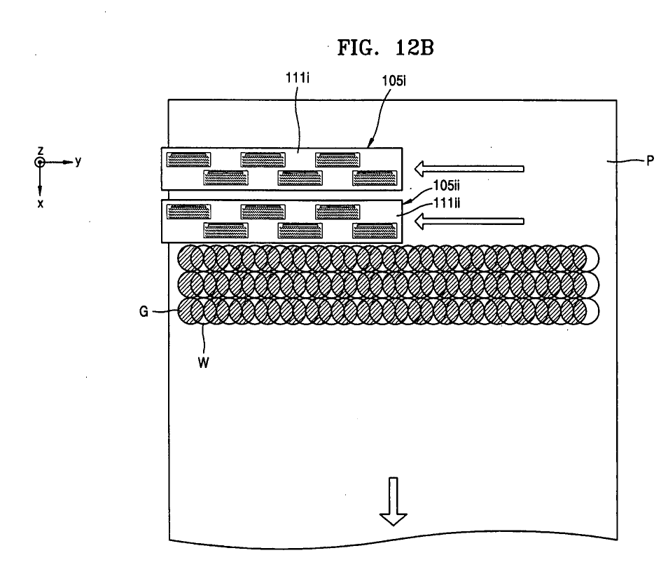

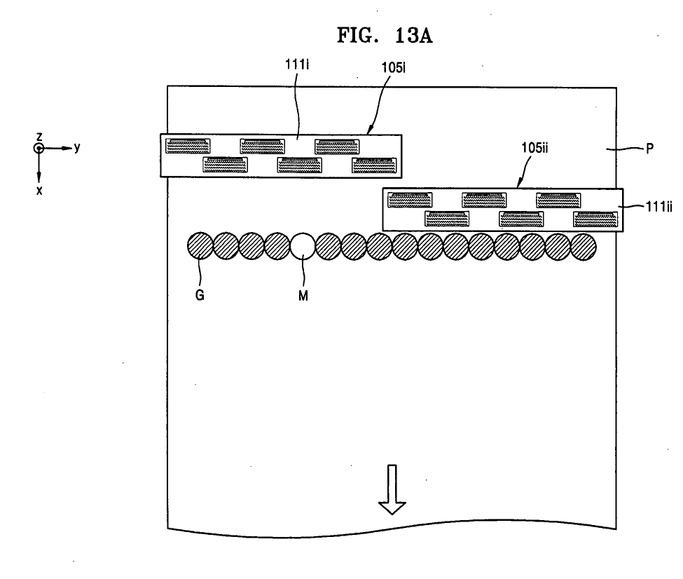

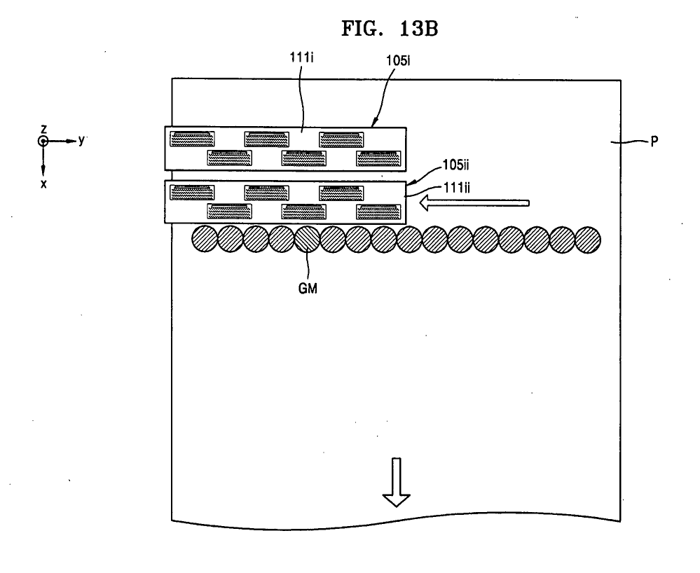

FIG. 9 illustrates an example of a printing pattern printed by an image forming apparatus according to an embodiment of the present general inventive concept. FIG. 10 illustrates another example of a printing pattern printed by an image forming apparatus according to an embodiment of the present general inventive concept. FIG. 11 illustrates still another example of a printing pattern printed by an image forming apparatus according to an embodiment of the present general inventive concept. FIGS. 12A and 12B illustrate yet another example of a printing pattern printed by an image forming apparatus according to an embodiment of the present general inventive concept. FIGS. 13A and 13B illustrate a printing pattern printed by an image forming apparatus according to an embodiment of the present general inventive concept when a malfunctioning nozzle is compensated for. The print media P in the drawings are transferred in the direction indicated by a single vertical directional arrow (i.e., the arrow pointing in the x direction), the first and second printheads 111i and 111ii are driven in a time-sharing manner, and, consequently, ink dots are deposited on the print medium P in a slant direction.

Referring to FIG. 9, the control unit 130 generates a control signal to arrange the first printhead 111i formed in the first printhead unit 105i and the second printhead 111ii formed in the second printhead unit 105ii in parallel to each other along the width direction of the print medium P so as to print an area corresponding to the width of the print medium P. By controlling the operations of the first and second printheads 111i and 111ii in this manner, the printing can be performed at a speed equal to a speed of printing performed using a printhead having a length corresponding to the width of a print medium P. That is, when printing in a normal mode or a draft mode, the high-speed printing can be performed by arranging the first and second printheads 111i and 111ii in this manner.

The control unit 130 generates a control signal to reciprocally move the first and second printheads 111i and 111ii in the main scanning direction, i.e., y direction, such that ink dots ejected by one of the printheads are deposited at positions between ink dots ejected by other printheads. In FIG. 10, gray circles G indicate ink dots ejected by the first printhead 111i disposed in the first printhead unit 105i and white circles W indicate ink dots ejected by the second printhead 111ii disposed in the second printhead unit 105ii. As illustrated in FIG. 10, the control unit 130 may control the operations of the first and second printheads 111i and 111ii such that the ink dots G ejected by the first printhead 111i disposed in the first printhead unit 105i are deposited at positions between ink dots W ejected by the second printhead 111ii disposed in the second printhead unit 105ii. When printing in the high-quality mode, the high-quality printing can be performed by operating the first and second printheads 111i and 111ii in this manner.

The control unit 130 may generate a control signal to arrange the first printhead 111i disposed in the first printhead unit 105i and the second printhead 111ii disposed in the second printhead unit 105ii to be parallel to each other during the high-quality mode printing, as illustrated in FIG. 11. Here, the control unit 130 may generate a control signal such that ink dots ejected by one of the printheads are deposited at positions between ink dots ejected by other printheads. In FIG. 11, gray circles G indicate ink dots ejected by the first printhead 111i of the first printhead unit 105i and white circles W indicate ink dots ejected by the second printhead 111ii disposed in the second printhead unit 105ii. As illustrated in FIG. 11, the control unit 130 may control the operations of the first and second printheads 111i and 111ii such that the ink dots G ejected by the first printhead 111i disposed in the first printhead unit 105i are deposited on positions between ink dots W ejected by the second printhead 111ii disposed in the second printhead unit 105ii. When printing in the high-quality mode, the high resolution printing can be performed by operating the printheads 111i and 111ii in this manner.

If the print medium P has, for example, an A5 size, printing is performed by arranging the first and second printheads 111i and 111ii in the manner illustrated in FIG. 11. Alternatively, if the print medium P has, for example, an A4 size, the first and second printheads 111i and 111ii arranged in the manner of FIG. 11 cannot perform high-quality printing. Thus, when the width of the print medium P is greater than the lengths of the first and second printheads 111i and 111ii, printing may be performed by simultaneously moving the first and second printheads 111i and 111ii in the main scanning direction, i.e., y direction, as illustrated in FIGS. 12A and 12B.

When malfunctioning nozzles are generated in one of the printheads, the control unit 130 generates a control signal to control another of the printheads to compensate for the malfunctioning nozzle. For example, assuming that a malfunctioning nozzle occurs in the first printhead 111i disposed in the first printhead unit 105i, FIG. 13A shows a printing pattern resulting from the malfunctioning nozzle. Ink dots G are deposited at positions corresponding to the ink dots ejected from normal nozzles, while an ink dot cannot be deposited at position M corresponding to the ink dots ejected from the malfunctioning nozzles. If the unprinted areas caused by the malfunctioning nozzle are not compensated for, the printing quality is degraded. Accordingly, the control unit 130 moves the other printhead, i.e., the second printhead 111ii, to the unprinted site and compensates for the malfunctioning nozzle by ejecting ink dots GM on the unprinted area corresponding to the position M of the malfunctioning nozzle, and moves the other printhead, i.e., second printhead 111ii, back to its previous position. The malfunctioning nozzle can be compensated for by repeating the above-described operations.

Hereafter, a high-quality printing method of the inkjet image forming apparatus according to an embodiment of the present general inventive concept will be described.

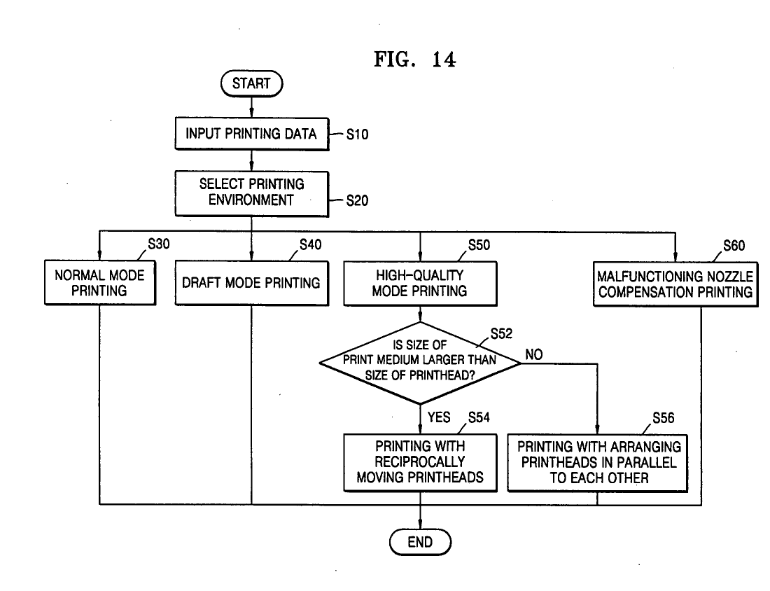

FIG. 14 is a flow chart illustrating a high-quality printing method of an image forming apparatus according to an embodiment of the present general inventive concept. Referring to FIGS. 7, 9-14, printing data is input to the image forming apparatus 125 through the host 200 in operation S10. After receiving the printing data from the host 200, a user selects a printing environment, for example, a printing mode such as a draft mode, a normal mode, and a high-quality mode, through the user interface 240 in operation S20. The control unit 130 operates the first and second printheads 111i and 111ii according to the input printing environment, and then the following image forming process is performed.

If an input resolution is equal to an actual resolution, the print medium P is printed in the normal mode or the draft mode input as a default mode in operation S30 or S40, respectively. The print medium P is transferred through a predetermined transferring path and discharged after printing an image thereon.

When printing in the normal mode in operation S30 or the draft mode in operation S40, printing is performed by arranging the first and second printheads 111i and 111ii to be parallel to each other along the width direction of the print medium P so as to print areas corresponding to the width of the print medium P, as illustrated in FIG. 9. When printing in this manner, printing can be performed at a speed equal to a printing speed of a printhead having a length corresponding to the width of a print medium P. That is, the normal mode and the draft mode can perform high-speed printing.

When printing in the high-quality mode in operation S50, the first and second printheads 111i and 111ii may operate corresponding to a size of the print medium P in operation S52. When the size of the print medium is larger than the sizes of the first and second printheads 111i and 111ii, the first and second printheads 111i and 111ii are reciprocally moved in the main scanning direction in operation S54, as illustrated in FIG. 10. Here, ink dots ejected by one of the printheads may be deposited on positions between ink dots ejected by the other printhead. Otherwise, the first and second printheads 111i and 111ii may be arranged to be parallel to each other and reciprocally moved in the main scanning direction for printing in operation S54, as illustrated in FIGS. 12A and 12B. Here, an ink dot ejected by one of the printheads may be deposited at a position between ink dots ejected by the other printhead. When printing in the high-quality mode, the high-quality printing can be performed by operating the first and second printheads 111i and 111ii in this manner. When the size of the print medium P is smaller than the sizes of the printheads 111i and 111ii, the first and second printheads 111i and 111ii may be arranged to be parallel to each other for printing in operation S56, as illustrated in FIG. 11. Here, ink dots ejected by one of the printheads may be deposited at a position between ink dots ejected by the other printhead.

When a nozzle malfunctions, the printing operation may be performed by compensating for the malfunctioning nozzle in operation S60. When a malfunctioning nozzle is generated in one printhead, the malfunctioning nozzle can be compensated for by the one or more of the other printheads for printing. For example, referring to FIGS. 13A and 13B, if a malfunctioning nozzle exists in the first printhead 111i disposed in the first printhead unit 105i, the malfunctioning nozzle can be compensated for by the second printhead 111ii disposed in the first printhead unit 105ii.

According to the structures and methods described above, the image forming apparatus and the high-quality printing method according to the present general inventive concept can decrease the number of head chips in the first and second printheads 111i and 111ii, for example by half, by printing using the first and second printheads 111i and 111ii with lengths equal to the half-width of a print medium, thereby printing in an optimum condition for each printing environment with respect to the printing modes or the occurrence of a malfunctioning nozzle.

As described above, the image forming apparatus and the high-quality printing method according to the present general inventive concept can realize an image forming apparatus suitable for a user's demands by printing under an optimum condition for each printing environment. In a draft mode or a normal mode, for example, printheads are arranged along the longitudinal direction of a print medium to increase a printing speed. In a high-quality mode, a photo-grade high-quality printing can be realized by moving each of the printheads or by arranging the printheads in parallel each other. In addition, the image forming apparatus and the high-quality printing method according to the present general inventive concept can enhance print quality by compensating for malfunctioning nozzles.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An inkjet image forming apparatus comprising:
a plurality of printhead units having lengths equal to or greater than a half-width of a print medium, being arranged along a transferring direction of the print medium transferred in a subsidiary scanning direction, being moveable along a main scanning direction, and having a plurality of nozzle units mounted thereon to eject ink onto the print medium to print an image;
a plurality of carriages corresponding to the plurality of printhead units upon which the plurality of nozzle units each having a plurality of nozzles are mounted;
a plurality of carriage moving units corresponding to the plurality of carriages to reciprocally move the plurality of carriages in the main scanning direction; and
a control unit to generate control signals to synchronize ejecting operations of the plurality of printhead units and operations of the plurality of carriage moving units so that the ink ejected from the plurality of nozzle units is deposited on a desired area of the print medium.

2. The inkjet image forming apparatus of claim 1, wherein the plurality of printhead units includes a first printhead unit and a second printhead unit.

3. The inkjet image forming apparatus of claim 2, wherein the control unit generates a control signal to arrange the first and second printhead units to be parallel to each other along a width direction of the print medium to print an area corresponding to a width of the print medium.

4. The inkjet image forming apparatus of claim 2, wherein the control unit generates a control signal to reciprocally move the first and second printhead units in the main scanning direction such that ink dots ejected by one of the printhead units are deposited on positions between ink dots ejected by the other of the printhead units.

5. The inkjet image forming apparatus of claim 2, wherein the control unit generates a control signal to control one of the printhead units to compensate for a malfunctioning nozzle of another of the printhead units.

6. The inkjet image forming apparatus of claim 2, wherein the control unit generates a control signal to arrange the first and second printhead units to be parallel to each other when printing in a high-quality mode.

7. The inkjet image forming apparatus of claim 6, wherein the control unit generates a control signal to deposit ink dots ejected by one of the printhead units at positions between ink dots ejected by the other of the printhead units.

8. The inkjet image forming apparatus of claim 2, wherein each of the plurality of carriage moving units comprises:
a mainframe;
a carriage moving motor;
carriage moving rollers, one being connected to the carriage moving motor and another being located in the main frame; and
a carriage moving belt connected to a corresponding carriage of the plurality of carriages and supported by the carriage moving rollers to reciprocally move the corresponding carriage of the plurality of carriages in the main scanning direction.

9. The inkjet image forming apparatus of claim 2, wherein each of the plurality of carriage moving unit comprises:
a guide rod connected to a corresponding carriage of the plurality of carriages and extending along the main scanning direction; and
a reciprocal driving unit to reciprocally move the guide rod in the main scanning direction.

10. The inkjet image forming apparatus of claim 9, wherein the reciprocal driving unit comprises:
a driving motor having a gear;
a connection gear including an outer circumference having gear teeth to mesh with the gear and an inner circumference having a female gear; and
a lead screw formed on the guide rod to mesh with the female gear of the connection gear.

11. The inkjet image forming apparatus of claim 1, wherein a plurality of head chips each having a plurality of nozzle arrays are arranged along the main scanning direction in each of the plurality of printhead units.

12. The inkjet image forming apparatus of claim 11, wherein the plurality of head chips are arranged in a zigzag pattern in each of the plurality of printhead units.

13. A high-quality printing method of an inkjet image forming apparatus having first and second printhead units having lengths equal to the half-width of a print medium and being arranged in a single line along the transferring direction of the print medium transferred in a subsidiary scanning direction, the first and second printhead units being moveable along the main scanning direction to eject ink onto the print medium to print an image, the method comprising:
receiving a printing environment input from a host; and
printing an image by moving the first and second printhead units according to the input printing environment.

14. The method of claim 13, wherein the printing of the image comprises printing by arranging the first and second printhead units to be parallel to each other along a width direction of the print medium and printing an area corresponding to the width of the print medium.

15. The method of claim 13, wherein the printing of the image comprises reciprocally moving the first and second printhead units in the main scanning direction and depositing ink dots ejected by one of the printhead units at positions between ink dots ejected by the other of the printhead units.

16. The method of claim 13, wherein the printing of the image comprises printing by compensating for a malfunctioning nozzle in one of the printhead units by controlling the other of the printhead units to compensate for the malfunctioning nozzle.

17. The method of claim 13, wherein the printing of the image comprises printing by arranging the first and second printhead units to be parallel to each other along a width direction of the print medium when printing in a high-quality mode.

18. The method of claim 17 further comprising:
depositing ink dots ejected by one of the printhead units at positions between ink dots ejected by the other of the printhead units.

19. The method of claim 17 further comprising printing by moving the first and second printhead units together in the main scanning direction.

20. An inkjet image forming apparatus, comprising:
a plurality of printhead units disposed along a subsidiary scanning direction parallel to a print medium path; and
a controller to selectively move the plurality of printhead units in a main scanning direction having an angle with the print medium path.

21. The apparatus of claim 20, wherein the plurality of printhead units are parallel to each other and spaced apart by a distance.

22. The apparatus of claim 20, wherein the controller moves one of the plurality of printhead units while not moving another one of the plurality of printhead units.

23. The apparatus of claim 20, wherein the controller simultaneously moves the plurality of printhead units.

24. The apparatus of claim 20, wherein the plurality of printhead units comprises first and second printhead units having first and second nozzle units, and the controller selectively controls the first and second nozzle units while moving at least one of the first and second printhead units.

25. The apparatus of claim 24, wherein the first and second nozzle units comprise first and second nozzles, and the controller selectively controls the first and second nozzles to compensate for a defective one of the first and second nozzles.

26. The apparatus of claim 20, further comprising a print medium;
wherein a distance between the plurality of printhead units and the print medium is about 0.5 mm to about 2.5 mm.

27. The apparatus of claim 20, wherein the controller comprises an interlace controller to control at least one of the plurality of print heads to eject interlacing ink droplets and a malfunction controller to control at least one of the plurality of print heads to compensate for at least one malfunctioning print head.

28. The apparatus of claim 27, wherein the interlace controller and the malfunction controller are a single controller.

29. An inkjet image printing method, comprising:
printing an image by interlacing ink droplets ejected from a plurality of print heads of an inkjet image forming apparatus.

30. The method of claim 29, further comprising:
printing the image by controlling at least one of the plurality of print heads to compensate for at least one malfunctioning print head.
